(19) United States
(12) Patent Application Publication
(10) Pub. No.: US 2025/0133341 A1
(43) Pub. Date: Apr. 24, 2025

(54) IMMERSIVE SEAT-CENTERED SOUNDSTAGE FOR VEHICLE INTERIORS

(71) Applicant: HARMAN BECKER AUTOMOTIVE SYSTEMS GmbH, Karlsbad-Ittersbach (DE)

(72) Inventor: Daniel BRACHT, Karlsruhe (DE)

(21) Appl. No.: 18/915,924

(22) Filed: Oct. 15, 2024

(30) Foreign Application Priority Data
Oct. 19, 2023 (DE) 102023128786.9

(51) Int. Cl. H04R 5/02; H04R 1/02

(52) U.S. Cl. CPC H04R 5/023; H04R 1/025; H04R 2499/13

(57) ABSTRACT

An audio system and a corresponding method for generating a virtual soundstage in a vehicle interior are described. A speaker array with at least a first and second central speaker is used, which is arranged centrally between two vehicle seats. In addition, pairs of seat speakers are located near the head regions of the occupants. A signal processing unit receives an input signal and controls the speakers. The central speakers are controlled with inverted and time-shifted signals in order to generate zero points in the radiation characteristics. These are directed at the ear regions of the head regions and thus center the perception of the virtual soundstage. The seat speakers create spatial sound envelopes around the head regions. By combining the central speaker array with targeted control and side seat speakers, an optimized seat-position-centered sound reproduction with an immersive sound impression is achieved.

### CROSS-REFERENCE TO RELATED APPLICATIONS

This application claims priority to the German Patent Application titled. “Immersive Seat-Centered Soundstage for Vehicle Interiors,” filed on Oct. 19, 2023, and having Application No. DE 10 2023 128 786.9. The subject matter of this related application is hereby incorporated herein by reference.

### TECHNICAL FIELD

The present disclosure relates to the field of audio system technology, in particular to an audio system and a method for generating a virtual soundstage in a vehicle interior.

### BACKGROUND

In modern vehicles, there is increasing interest in offering passengers an immersive sound experience. Traditional vehicle audio systems use multiple speakers placed throughout the vehicle's interior to deliver the best possible sound. However, these systems can have limitations in terms of precisely localizing sounds and creating a coherent soundstage that surrounds the listener, in that the soundstage perceived by listeners can often be attributed to the positions of speakers. Therefore, conventional systems can struggle to provide an immersive envelopment of a seat-centered soundstage for a passenger at individual seating positions in the vehicle.

There is therefore a need for improved systems and methods for generating a virtual soundstage for vehicle interiors that enable a more precise and immersive sound experience.

### SUMMARY

Advantageous features of these disclosures are the subject of the appended claims.

In the following disclosure, the disclosed solution is described with respect to the claimed audio systems and the claimed methods for generating a virtual soundstage, as well as with respect to corresponding computing devices, computer programs, and computer-readable data carriers. Features, advantages or alternative exemplary embodiments can be assigned to the respective other categories, and vice versa. The methods may be enhanced by features described and/or claimed in the audio systems, and conversely, the audio systems may comprise any steps or features described in the methods.

An audio system is configured to create a virtual soundstage, particularly in a vehicle interior. The audio system includes a speaker array comprising at least a first and a second central speaker. The speaker array is arranged with respect to a lateral positioning in the vehicle interior between a first and a second vehicle seat. The speaker array can be positioned centrally with respect to a transverse direction in the listening environment.

In some examples, the center point or center plane of the speaker array may be centered with respect to the listening environment and/or with respect to the two vehicle seats, which may define listening positions, particularly head positions or head regions of listeners or occupants. A head region may refer to the ideal or typical spatial region in which the head of a person is located when sitting in the vehicle seat, in particular when sitting centrally on the seat and facing forward, assuming an ideal or typical listening pose, that is, looking straight ahead.

In some examples, the speaker array may be located laterally between two head regions that may be associated with vehicle seats that may be associated with listening positions, particularly head positions of listeners or occupants. For example, the central speaker array can be positioned longitudinally in front of the seats and transversely between two vehicle seats in the vehicle interior. The speaker array, in particular the center of the speaker array, can therefore be offset in the transverse direction from the position of the head region of a vehicle seat (e.g. the head region can be offset transversely with respect to the center of the speaker array and the center of the speaker array can be offset with respect to the head region of the vehicle seat). The vehicle seat can be positioned laterally offset from the center of the listening environment. The speaker array can be located centrally in the listening environment, for example in front of the driver's seat and/or the passenger seat, for example in a dashboard.

In some examples, the speaker array may be arranged, with respect to the transverse direction, between two head regions associated with two vehicle seats, in particular centrally therebetween. The head regions are associated with different vehicle seats, in particular a first head region is associated with a first vehicle seat and a second head region is associated with a second vehicle seat, wherein the vehicle seats can be arranged to the left and right of the central speaker array. The head regions of the vehicle seats may correspond to listening positions in which the head of an occupant or listener is typically positioned when seated in the vehicle seat. A listener's head may have a central ear (and a corresponding portion of the head region) pointing toward the center and an ear pointing away from the center.

Transverse (e.g., lateral, sideways, or transverse) can refer to a direction that is perpendicular to the long axis, in other words the longitudinal axis, of the vehicle, therefore perpendicular to a central axis of the audio system in the longitudinal direction, transverse to the typical direction of travel and/or the orientation of the vehicle seats. Front, or a forward direction, can refer to a typical direction of travel, or to an orientation or direction of view of the vehicle seats. A vehicle dashboard may be located at the front of the vehicle, in the typical line of sight of the occupants.

Longitudinal can refer to a direction that runs along the length of the vehicle from front to rear (e.g., along the longitudinal axis of the vehicle), for example in the typical direction of travel and/or along the orientation of the vehicle seats or typical line of sight of the occupants. For example, the directions can also refer to a typical seating position of an occupant of the vehicle seat, where transverse can describe a lateral direction or orientation across the seat or typical orientation/pose of the occupant or listener. Similarly, longitudinal can describe a direction or orientation in the longitudinal direction of the seat or along the typical orientation/pose of the occupant or listener.

The audio system further comprises a pair of seat speakers in each of the two vehicle seats, wherein the corresponding pair of seat speakers is arranged in each of the two vehicle seats such that an ideal or typical head region of a person sitting on the respective vehicle seat is arranged between the corresponding pair of seat speakers.

In some examples, the audio system comprises at least a first and a second seat speaker, or more generally near-field speakers, placed at or near a first head region and sending near-field sound signals directly to the first head region. In other words, near-field speakers or individual head region speakers are positioned near each head region and are controlled individually for each seating region or head region. The first head region is thus associated with a first vehicle seat and arranged in a laterally offset position to the central speaker array, wherein it has at least first and second seat speakers associated with the head region. A second vehicle seat can be configured accordingly with a third and a fourth seat speaker. Additional vehicle seats that may be adjacent to the center of the listening environment can be configured accordingly.

The audio system also comprises a signal processing unit that is connected to the speaker array and the seat speakers. The signal processing unit comprises at least one processor and memory for audio signal processing and generation of audio signals, and sends generated audio signals to the speakers to control them so that they generate sound signals. The signal processing unit is configured to receive an input audio signal. The signal processing unit generates a first central audio signal and a second central audio signal based on or using the input audio signal. The signal processing unit controls, based on processing the input audio signal, the first speaker with the first central audio signal and the second central speaker with the second central audio signal. The second central audio signal is inverted with respect to the first central audio signal and is shifted forward or delayed in time by a predetermined period of time, as will be described in more detail with reference to the figures. Due to this delayed control of the second central speaker with an inverted audio signal, a zero point, or in other words a minimum in the sound pressure generated by the speaker array, is shifted in the radiation characteristic of the speaker array towards the head region of the first vehicle seat.

The first head region may have a central side, or a central side region, facing or oriented toward the center of the listening environment and/or pointing toward the second vehicle seat. The zero point can be oriented or positioned relative to the central side region of the head region. The zero point (e.g., and/or a zero point line or axis) may at least partially intersect or overlap the central side region. Typically, one of a listener's ears can be located in this region, so that the listener perceives a reduced sound pressure with this ear compared to the other ear facing outwards. Therefore, the central side region can also be called the ear region or inner ear region. The ear region can therefore be a subregion of the ideal head region in which the (central, e.g., pointing towards the center) ear of the occupant/listener is located in an ideal or typical sitting pose. The first zero point can run between the first and second vehicle seat, or be located between the vehicle seats. The second zero point can run between the first and the second vehicle seat, or be located between the first and the second vehicle seat. The first and second zero points can both run or be located between the first and second vehicle seats. The respective zero point axis describing the first and/or second zero point can run from the center of the speaker array between the vehicle seats. The speaker axis connecting the centers of the central speakers can run between the first and second vehicle seats.

In the described audio system with a central speaker array, the dipole radiation characteristic created by superposition of the first and second central speakers by inversion has a zero point. The zero point is a point, set of points, axis, line, or region where the sound pressure is reduced to a minimum by interference. It can also be referred to as the region or axis of sound pressure minimum or sound pressure cancellation. At the zero point, the sound pressure is greatly attenuated or equal to zero; around the zero point, the sound pressure is in any case still attenuated. By specifically controlling the speaker array, the position of the zero point and thus the directional characteristics can be influenced. A shift of the zero point leads to a shift of the region with minimized sound pressure. The zero point is used to influence the perception of the virtual sound source center.

A first zero point in the radiation characteristics of the sound signals of the speaker array encounters the ideal head region of the first vehicle seat, not in the middle but laterally shifted to the side (e.g., in the central side region). Thus, the zero point is located at least partially in a region in which a central ear of an occupant is located (e.g., the ear pointing towards the center of the audio system). This region may be referred to as the center-facing side region, which may be positioned adjacent to the head region, or may at least partially intersect the head region on the hemisphere of the head region facing the center. This ensures that on the central side of the head region, especially in the peripheral region where the ear of a listener is located, a reduced sound pressure based on a reproduction of the audio input signal prevails through the zero point and the localization of the presented sound event is influenced.

The first zero point encounters the ideal head region near one ear of the person sitting on the first vehicle seat, which is facing the other vehicle seat when both people on the two vehicle seats are looking in the same direction (e.g., forward).

The zero point creates a reduced sound pressure, resulting in the center of the virtual soundstage, as a listener would perceive it, being centered directly in front of the head region. In addition, based on the processing of the input audio signal, the signal processing unit controls the first seat speaker with a first seat speaker audio signal and the second seat speaker with a second seat speaker audio signal. The sound signals from the seat speakers overlap with the sound signals from the speaker array and generate a spatial sound envelopment of the virtual soundstage around the head region based on the virtual soundstage, which is perceived to be centered in front of the occupant.

In some examples, the head region, particularly the ear region, may be at least partially in the near field of the speaker. For example, the near field can refer to the fact that the distance in a free field without reflections is, for example, less than ¼ of the wavelength of the lowest frequency to be reproduced, but the distances for the seat speakers have to be chosen smaller due to multiple reflections in the vehicle.

The first seat speaker may be positioned in a near field region in a left hemisphere and the second seat speaker may be positioned in a near field region in a right hemisphere of the first head region associated with a first vehicle seat. So the first seat speaker can be located near the left half of the head region, in other words in the near field region of a listener's left ear, and the second seat speaker can correspondingly be located in the right half, or vice versa. This arrangement creates a spatial sound envelope around the listener's head. The seat speakers are arranged close to the head region, especially in the central side region (ear region). In some examples, the ear region is less than 20 cm, or 15 cm, or 10 cm, or 5 cm from the seat speakers, where the reference may be selected, for example, to be a diaphragm (or the center of the diaphragm) of the speaker, or the center of the speaker, or the point of the speaker closest to the head region on the one hand, and the listener's ear, or the center of the ear region, or the point of the ear region closest to the speaker on the other.

In another example, for example, the speaker may be positioned less than 15 cm, or less than 20 cm, or less than 30 cm, or less than 40 cm, from the center of the head region to produce a good sound impression in the near field. The first and second seat speakers may be positioned in a rear or front hemisphere of the first head region. The seat speakers may be headrest speakers arranged in a headrest of the first vehicle seat. The same applies to the seat speakers of the second vehicle seat. The seat speakers can be positioned centrally relative to the ideal head region of the respective vehicle seat.

The first and second central speakers are arranged in a compact spatial configuration. The distance between the speakers can be smaller than, for example, 100%, or <75%, or <50%, or <25%, or <10%, or <5% of the diameter of one of the speakers, or, for example, <5 mm, or <10 mm, or <20 mm, or <30 mm, or <5 cm, or <10 cm. The distance between the centers of the first and second speakers may be chosen to be less than half the speaker diameter of the first speaker plus half the speaker diameter of the second speaker plus 5 mm, or 10 mm, or 20 mm, or 30 mm, or 5 cm, or 10 cm. Alternatively, the central speakers may be arranged directly adjacent to each other. This allows the position of the zero points in the radiation characteristics of the central speaker array to be efficiently controlled.

In the audio system, the first and second central speakers may each comprise a full-range speaker or a mid-high-frequency speaker. The first and second speakers may be configured to emit sound signals with the same frequency range and/or the same radiation characteristics. The first and second central speakers can be identical speakers. For example, it is also possible for each central speaker to consist of a pair of speakers (e.g., a midrange speaker and a tweeter). In this case, the pair of speakers, e.g. the midrange speaker and the tweeter, can be arranged longitudinally one behind the other. The central speakers can be located in a vehicle's dashboard or in the vehicle roof. The audio system can comprise at least two central speakers, and both can be designed as mid-high frequency speakers, for example as identical speakers. These two main speakers are positioned so that they are embedded, for example, in the dashboard of the vehicle or in its roof lining, and thus centrally in front of the vehicle seats.

The orientation of the central speaker array can be defined by the connection line (e.g., the axis on which the centers of the first and second speakers lie). This axis can also be called the speaker axis. It is possible that the speaker axis is oriented along (e.g., parallel to) the longitudinal axis of the vehicle (longitudinal axis). To visualize this spatial orientation, you can imagine the position and orientation of the speakers in a three-dimensional projection onto the vehicle floor or the X/Y plane. This means that when looking at the vehicle from above (top view), the orientation of the speaker axis in relation to the vehicle axes can be seen.

In some examples, the speaker axis could be positioned at an angle greater than 5°, or 10°, or 20°, or 30°, or 45° or 60° to the longitudinal axis. By rotating the speaker axis, the audio output can be optimally adapted to the positions of the vehicle seats and the lateral and longitudinal position relative to the seat positions.

The signal processing unit generates and uses specific audio signals to control each speaker. The first and/or second central audio signal may comprise an audio signal correlated with the input audio signal.

For example, a correlated audio signal may comprise a signal that has a significant similarity or relationship to an original input audio signal, particularly in terms of its waveform or pattern. This means that changes or patterns in one signal often replicate or reflect similar changes or patterns in the other signal. A “correlated audio signal” in a claim excludes decorrelated signals such as those resulting from reverberation effects.

In some examples, the correlation may comprise both signals having similar waveform patterns, meaning that the peaks and valleys of the correlated signal correspond to those of the input audio signal. A further indication of the correlation could be a coherent phase relationship between the two signals, so that despite possible temporal shifts the phase structures of both signals remain constant relative to each other. In addition, frequency domain analysis can show that both signals have similar spectral contents, indicating a correlation of their frequency patterns. Finally, the correlated signal might have a certain energy or amplitude relation to the original input audio signal, indicating that it was derived from the original signal through certain amplification or attenuation processes.

The audio system may be configured such that the seat speaker audio signals include decorrelated audio signals with respect to the input audio signal and/or the central audio signals.

To achieve improved spatial audio perception in a vehicle, the seat speaker audio signals do not directly reflect the input signal. This can be called decorrelation. A decorrelated audio signal has little or no discernible relationship to the original input audio signal. Decorrelated signals often include spatial effects such as multiple reflections, diffuse field effects or reverberation effects, where many reflected sound waves come together to create a complex combination of signals that are significantly different from the original signal.

Because the seat speaker audio signals are decorrelated to the input audio signal, this means that they do not have the same characteristics or patterns of the input signal. This may mean that even though both signals originate from the same audio source, the waveforms of the signal reproduced by the seat speakers are significantly different compared to the input audio signal. The phase relationship between the two signals could be inconsistent or variable, breaking the coherent structure of the original signal. In the frequency domain, the spectral contents of the decorrelated signal may deviate from the input audio signal by more than a predetermined limit value. The energy or amplitude relation may also not be constant or predictable, indicating independent amplification or attenuation processing of the seat speaker signal. The aim of this decorrelation is to ensure an enveloping and spatial sound experience in the vehicle interior.

The audio system may be configured such that the seat speaker audio signals include reverberated audio signals based on the input audio signal and/or the central audio signals. The audio system can be designed in such a way that the sound signals emitted by the speakers in the seats are processed with an echo or reverberation. The reverb can be based on the original audio input and/or on the audio signals from the center speakers.

The audio system may comprise at least a third and a fourth seat speaker positioned in a second head region associated with a position of a second vehicle seat. For example, the first head region may be located in a left hemisphere of the listening environment and the second head region may be located in a right hemisphere of the listening environment. The center of the compact speaker array should be located transversely between the first and second listening regions. The center of the compact speaker array can be positioned on a longitudinal axis, in particular a central axis or axis of symmetry, between the first and the second head region. The signal processing unit of the system may be further configured to, based on the processing of the input audio signal, drive the third seat speaker by means of a third seat speaker audio signal and the fourth seat speaker by means of a fourth seat speaker audio signal to generate a spatial sound envelope of the virtual soundstage around the second head region.

In some examples, the first and second seat speaker audio signals may be generated based on or using the position of the first head region in the listening environment. In some examples, the third and fourth seat speaker audio signals may be generated based on or using the position of the second head region in the listening environment. This creates an interactive, immersive listening environment for two listeners.

In these examples, an improved and spatial sound envelopment for two occupants of a vehicle can be generated by placing an additional pair of seat speakers near the second head region, usually the passenger side. By positioning the compact speaker array and the additional seat speakers close to the respective listening positions, an immersive sound experience can be created with a soundstage in front of the listener, and also around the listener with enveloping surround sound for both respective occupants of the vehicle, which is perceived in each case centered in a longitudinal position in front of the respective occupant.

The first and second central speakers, in particular the centers of the speakers, can be arranged on an axis through a center between the first and second head regions. This can help ensure that both the driver and the passenger experience a harmonious and centered sound experience in a vehicle.

A first zero point of the compact speaker array can be shifted towards the head region of the first vehicle seat. A second zero point of the compact speaker array, which is symmetrical to the first zero point with respect to a longitudinal axis through the centers of the first and second central speakers, can be shifted in the direction towards the head region of the second vehicle seat.

The first and the second central speaker, in particular their centers or center points, can be arranged on a longitudinal axis of symmetry or plane of symmetry of the first and second head regions, positioned longitudinally one after the other. The connection line or speaker connection axis between the centers of the speakers can run in the longitudinal direction.

The speaker that is closer to the vehicle seats or listening positions/head regions can receive the delayed signal.

However, it is also possible that the connection line runs at an angle of less than 5°, or less than 10°, or less than 20°, or less than 45°, or less than 60°, or less than 90° to the longitudinal direction. In particularly preferred examples, the angle may be 90° or 0°.

The position of the center of the speaker array may deviate from a central position in the transverse direction and be adjusted accordingly in the longitudinal direction so that the first zero point and the second zero point run in the direction of the first head region and the second head region, respectively.

The compact speaker array generates a zero point on both sides of the speaker axis, or in both half spaces relative to the speaker axis, which can be referred to as the first and second zero point. The speaker array can form zero points on both sides of the connection axis, or connection plane, between the first and the second central speaker.

In particularly preferred examples, the central speakers can be arranged in a longitudinal arrangement (e.g., on a longitudinal axis of the vehicle interior) in particular a central axis between the head regions in the longitudinal direction. Due to the symmetry of the array's directional characteristics, two seats, or their head regions, can each be treated with a zero point, or overlapped.

The first and/or second speaker can have symmetrical radiation characteristics. In this case, the zero points or axes of the zero points can also be symmetrical to the connection axis or plane.

A first zero point can be aligned with the first head region, in particular with a central side region where an ear of the listener is positioned, and the second zero point can be aligned with the second head region, in particular with a central side region where an ear of another listener is positioned. This can create the impression of a seat-centered virtual soundstage for one or two listeners.

One of the first or second central speakers may be located longitudinally closer to the center of the listening environment or closer to the vehicle seats, or closer to at least one of the head regions. This central speaker can be controlled with the central audio signal delayed by the time period.

The central audio signal of the speaker that is closer to the center of the listening environment may have a time delay relative to the other central audio signal. The skilled in the art knows various signal processing techniques to manipulate the phase and temporal offset of audio signals. These include, for example, delay filters, all-pass filters, phase shifters or time offset blocks in digital signal processors. These could be used to shift the second central audio signal in time with respect to the first central audio signal. Likewise, in audio technology, methods for inverting audio signals are within the prior art. Phase inverters or digital signal processing can be used for this purpose. The speakers of the central speaker array and the seats are placed with high spatial accuracy (e.g., at defined mounting points). Thus, the resulting directional characteristics or the position of the zero points can be computationally predetermined and optimized using sound field simulations for a given speaker arrangement, for example through optimizations. The simulation can thus be used to optimize the time offset. Using measuring methods such as near-field scanning, the radiation characteristics of the speaker system can be measured. Thus, the person skilled in the art is familiar with techniques, in particular all necessary simulation, measurement and optimization techniques, both for speaker positioning, signal inversion and for setting the time offset between the channels, in order to implement the required control of the speaker signals and positioning of the speakers for the desired directional characteristic and control of the zero points relative to the head regions.

A corresponding method for generating a virtual soundstage in a vehicle interior is provided.

The method for generating a virtual soundstage in a vehicle interior is based on an audio system with the following components: A speaker array having at least a first and a second central speaker centrally located in the vehicle interior. At least one first and one second seat speaker positioned proximate a first head region associated with the laterally offset position of a first vehicle seat. A signal processing unit connected to the speaker array and the seat speakers that receives an input audio signal to generate corresponding audio signals for the speakers.

The method is carried out by the signal processing unit and comprises the following steps.

In one step, an input audio signal is received by the signal processing unit. In a further step, based on the processing of the input signal, the first central speaker is controlled with a first central audio signal and the second central speaker with an inverted and delayed second central audio signal. This shifts a zero point of the radiation characteristic towards the head region of the first seat and creates a reduced sound pressure, which localizes the center of the virtual stage in a centered position in front of the head region. In a further step, also based on the processing of the input signal, the first seat speaker is controlled with a first seat speaker audio signal and the second seat speaker with a second seat speaker audio signal, thereby creating a spatial sound envelope around the head region.

The method may also include one or more or any combination of features or steps described in connection with the audio systems disclosed herein.

The method may be a computer-implemented method, for example, executed by at least one computing device.

A computing device, for example a computing apparatus or computer or signal processing unit, for generating a virtual soundstage in a vehicle interior comprises a computing unit (processor), a storage unit (memory), optionally an interface for receiving and providing audio signals, wherein the storage unit comprises instructions executable by the computing unit which, when executed by the computing unit, cause it to perform the steps of any method or any combination of methods according to the present disclosure.

A computer program, or computer program product, comprises instructions that, when executed by a processor, cause the processor to perform the steps of any method or combination of methods according to the present disclosure.

For example, a computer program may include software that can be loaded into a memory of a programmable control device or a computing unit of a medical imaging system. With this computer program product, the described methods can be carried out when the computer program product is running in the control device. The computer program product may require program resources (e.g., libraries and auxiliary functions) to implement the described methods. The claim directed to the computer program product is intended in particular to protect software with which the described methods can be carried out. The software can be a source code (e.g., C++) that still needs to be compiled and linked or that only needs to be interpreted, or it can be an executable software code that only needs to be loaded into the corresponding computing unit or control device for execution.

A computer-readable data carrier comprises instructions that, when executed by a processor, cause the processor to perform the steps of any method or combination of methods according to the present disclosure. For example, the data and instructions for executing the disclosed method may be stored in a distributed database, in particular a cloud.

For example, the data carrier may comprise a DVD, a magnetic tape, a hard disk or a USB stick on which electronically readable control information, in particular the described software, is stored. If this control information (software) is read from the data carrier and stored in a control device or computing unit of a magnetic resonance system, the methods described can be carried out.

The audio system, the computing device, the computer program or computer program product, and the computer-readable data storage are configured to perform any method or combination of methods according to the present disclosure.

For such devices, computer programs, cloud solutions and electronically readable data carriers, technical effects can be achieved that correspond to the technical effects for the device according to the present disclosure.

A vehicle comprises any audio system according to the present disclosure.

Although the features described in the summary above and the detailed description below are described in the context of specific examples, it is to be understood that the features may not only be used in the respective combinations, but may also be used in isolation or in any combination, and features from different examples of the systems, devices, and methods may be combined with each other and thus correlate with each other, unless expressly stated otherwise.

The above summary is therefore intended to provide only a brief overview of some features of some embodiments and implementations and is not intended to be limiting. Other embodiments may include additional features than those described above.

### BRIEF DESCRIPTION OF THE DRAWINGS

The disclosure is explained in more detail below using preferred embodiments with reference to the accompanying drawings.

In the figures, identical reference numerals designate identical or similar elements. The figures are schematic representations of various embodiments of the claimed solution, wherein the elements shown in the figures are not necessarily shown to scale. Rather, the various elements shown in the figures are reproduced in such a way that their function and general purpose are understandable to the person skilled in the art.

FIG. 1 shows a dipole radiation characteristic of the first and second central speakers without signal delay, according to a non-claimed example.

FIG. 2 shows a dipole radiation characteristic of the central speaker of FIG. 1 with signal delay, according to various exemplary embodiments.

FIG. 3 illustrates the localizations of virtual seat-centered soundstages based on shifting the symmetrical zero points of the dipole radiation characteristics of the central speakers, according to various exemplary embodiments.

FIG. 4 illustrates virtual enveloping soundstages for the occupants of a vehicle, according to various exemplary embodiments.

FIG. 5 shows a flow chart with steps for carrying out a method for generating virtual soundstages, according to various embodiments.

FIG. 6 shows a schematic drawing of an audio system configured to generate virtual soundstages according to various exemplary embodiments.

### DETAILED DESCRIPTION OF EXEMPLARY EMBODIMENTS

In the following, concepts of exemplary embodiments are explained in more detail with reference to the accompanying drawings.

The properties, features and advantages described above and the manner in which they are achieved will become clearer and more clearly understood in connection with the following description of exemplary embodiments. It should be noted that the description of the exemplary embodiments is not to be understood in a limiting sense. The scope of the claimed solution should not be limited by the exemplary embodiments described below or by the figures, which serve only for illustrative purposes.

The drawings are to be considered as schematic representations and the elements shown in the drawings are not necessarily to scale. Rather, the various elements are presented in such a way that their function and general purpose become clear to a person skilled in the art. Any connection or coupling between functional blocks, devices, components, modules or other physical or functional units shown in the drawings or described herein may also take place by direct or indirect connection or coupling. A connection between the components can also be established via a wireless connection. Function blocks can be implemented in hardware, firmware, software, or a combination thereof.

Below, various techniques for creating a seating position-centered enveloping virtual soundstage are described in more detail. The disclosed techniques are described in the context of an interior of a vehicle, but it is to be understood that the techniques are not limited in this regard and may be used in any scenario, exterior or interior, in which a central compact speaker array and individual near-field speakers for a listener are arranged. For example, in an interior video projection room, conference room, cinema, any other vehicle such as an aircraft or ship, and other situations where a speaker array is not centrally located in front of one or more listeners, and wherein a mechanical structure such as a seat is present near the listeners.

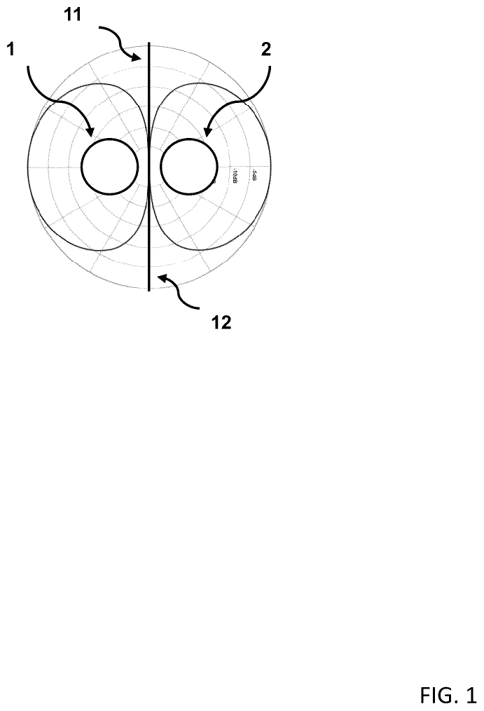

FIG. 1 shows a dipole radiation characteristic of a speaker array comprising a first central speaker 1 and a second central speaker 2, without signal delay, according to a non-claimed example.

In the example of FIG. 1, the central speakers are arranged symmetrically with respect to a central axis. One speaker is located in the left hemisphere and the other in the right hemisphere of the radiation characteristic. The two speakers are operated without signal delay, but with an inverted second central audio signal, wherein the reference numerals 11 and 12 indicate a first and a second zero point in the dipole radiation characteristic, which run along the central axis.

The two speakers 1,2 are operated in a dipole configuration. This means that a speaker signal from one of the speakers is inverted compared to the signal from the other speaker, but without a time shift. Such a configuration leads to destructive interference in the center plane between the speakers, which creates the zero points 11, 12 (e.g., respective vectors or axes of zero points) in the radiation characteristic. These zero points, at which the perceived sound pressure is greatly reduced or essentially zero, can run along the zero axes. A zero point can be characterized by an axis or direction and run along it.

As can be seen in FIG. 1, the zero points run along the center plane between the speakers (e.g., centrally between them).

For example, a processor such as a DSP (digital signal processor) can be used to generate the zero point in the radiation characteristic and make it controllable. This can be achieved by feeding an inverted signal into one of the speakers and/or by adding a time delay to the signal from one of the speakers to direct the zero point to a specific position or in a specific direction, as explained in more detail below.

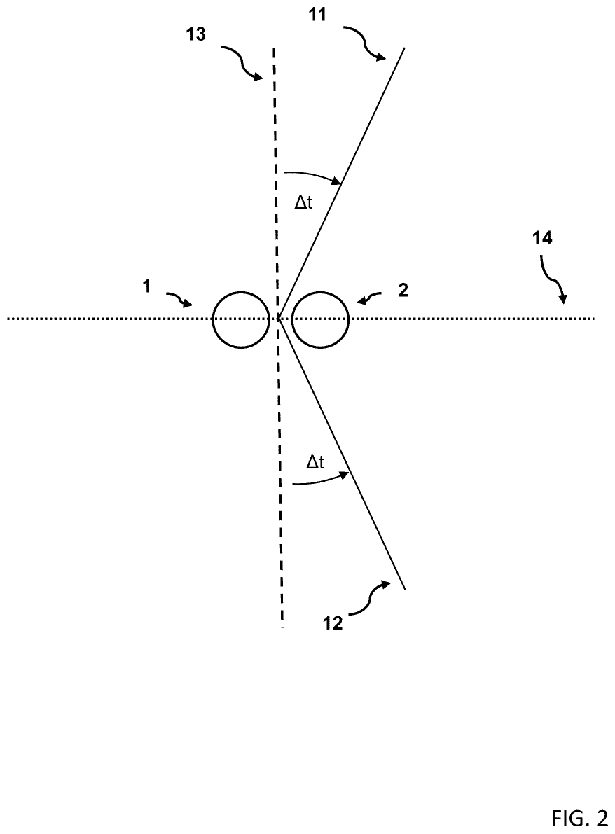

FIG. 2 shows a dipole radiation characteristic of the central speakers 1, 2 of FIG. 1 with signal delay by a predetermined time period At, according to various exemplary embodiments.

As can be seen in FIG. 2, a dipole radiation characteristic is generated by a first central speaker 1 and a second central speaker 2, similar to that in FIG. 1. In the center a dashed central axis 13 is shown.

In contrast to FIG. 1, in FIG. 2 the zero points 11 and 12 are not arranged along the central axis, but along an axis that is rotated by a certain angle relative to the central axis. This rotation of the zero axis is caused by the second central audio signal of the second central speaker 2 being inverted and additionally delayed in time by a time period At compared to the first central audio signal of the first central speaker 1.

Due to this time delay of the inverted signal at the second central speaker 2, the resulting zero point axis in the dipole radiation characteristic shifts and rotates accordingly by the angle relative to the central axis between the two central speakers 1 and 2.

A dashed speaker axis 14 can be seen between the centers of the two central speakers 1 and 2. Due to the signal delay, the dipole radiation characteristic is no longer symmetrical with respect to the central axis 13, unlike in FIG. 1. However, the zero points 11 and 12 are arranged symmetrically with respect to the speaker axis 14 between the centers of the central speakers 1 and 2, since the central speakers 1, 2 individually have a radiation characteristic that is symmetrical with respect to the central axis 13.

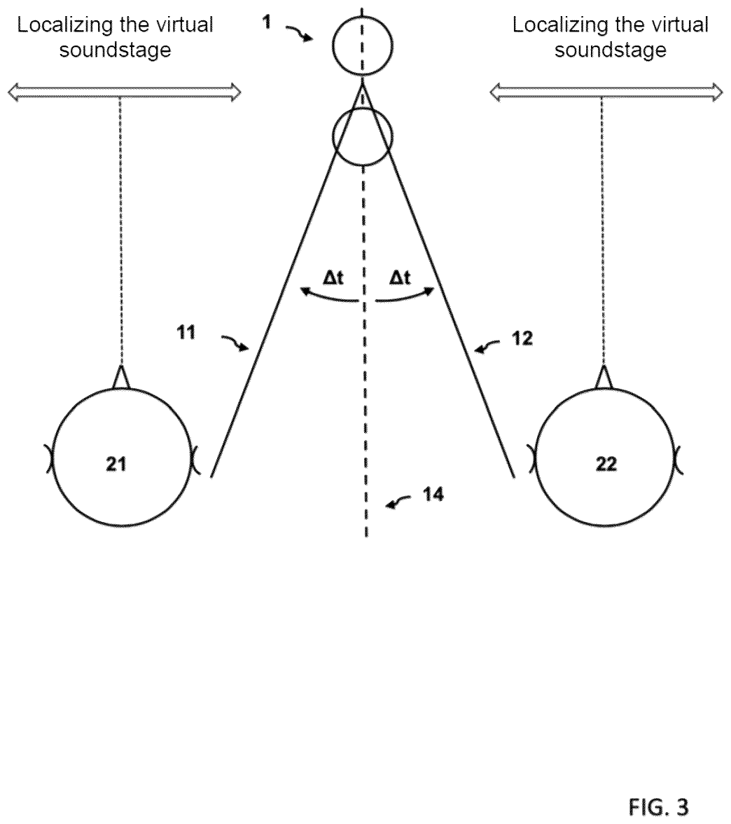

FIG. 3 illustrates the localizations of virtual seat-centered soundstages based on shifting the symmetrical zero points 11, 12 of the dipole radiation characteristics of the central speakers 1, 2, according to various exemplary embodiments.

FIG. 3 shows the two central speakers 1 and 2, which were also shown in FIGS. 1 and 2. A dashed central axis runs between the centers of the central speakers 1 and 2.

Furthermore, head regions 21, 22 are shown, which represent typical or ideal head positions of persons positioned on vehicle seats to the left and right of the central speaker array. At the zero points 11, 12, delays At are shown, which indicate that the audio signals of the central speakers are offset in time from each other.

Furthermore, zero points 11, 12 of the resulting dipole radiation characteristic are shown, the zero points each lying on an axis which is rotated by a certain angle with respect to the central axis between the central speakers. The axes or directions of the zero points 11, 12 are symmetrical with respect to the speaker axis, and thus they can each be controlled to a different head region associated with a different one of the first and second vehicle seats.

The locations of the virtual soundstage to the left and right of the central speakers indicate that by positioning the zero points 11 and 12 based on the signal delay, the virtual soundstages are shifted laterally from the center due to the reduced sound pressure at one of the two ears and are perceived as centered for the people in the seats.

In FIG. 3, the central speakers 1 and 2 are positioned so that their centers are on a longitudinal axis between the two head positions 21 and 22. Head positions 21 and 22 represent ideal or typical head regions of persons positioned on seats in the vehicle and looking straight ahead in the direction of travel.

The zero points 11 and 12 of the resulting dipole radiation characteristic are each directed towards the side head regions, in particular towards the side regions of the head regions 21 and 22 pointing towards the center. This means that the zero points at least partially overlap the region of the head region in which one of the listener's ears is located.

Through this targeted orientation of the zero points 11 and 12 to the lateral head regions in which the ears are positioned, the perception of the sound source center of the virtual soundstage is centered in front of his or her respective head region for each listener in seats 21 and 22.

The longitudinal positioning of the central speakers 1, 2 between the head regions in combination with the lateral orientation of the zero points to the ear regions of the head regions thus enables an individual, seat position-centered perception of the virtual soundstage for each listener in the vehicle.

Overall, FIG. 3 shows how the localization of the virtual soundstage can be individually adjusted for each listener in seats 21 and 22 by shifting the zero points in the dipole radiation characteristic using signal delay.

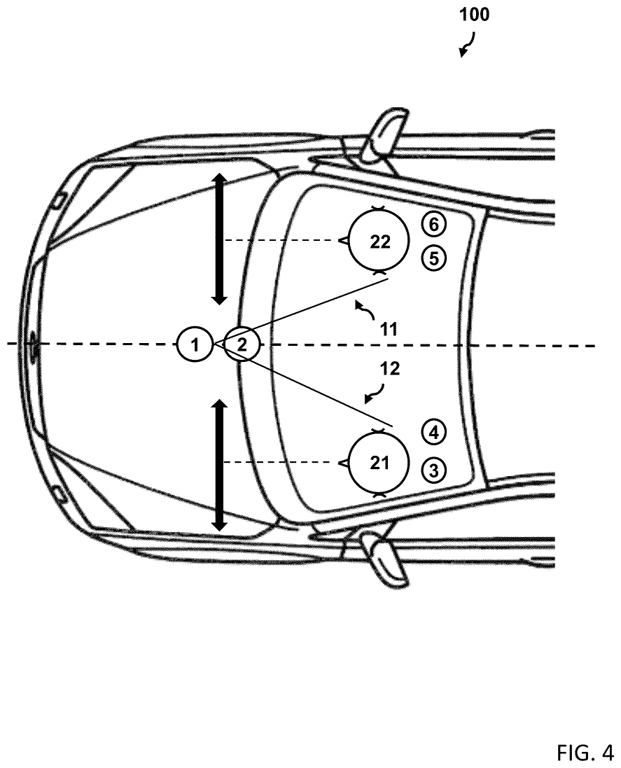

FIG. 4 illustrates virtual enveloping soundstages for the occupants of a vehicle, according to various exemplary embodiments.

FIG. 4 schematically shows an audio system 100 for generating virtual soundstages in a vehicle interior according to various exemplary embodiments.

In the central region of the vehicle, a speaker array, as explained in FIG. 4, with a first central speaker 1 and a second central speaker 2 is arranged, for example in a dashboard or vehicle roof. The central speakers 1 and 2 are arranged in a compact spatial configuration.

The central speakers 1 and 2 each comprise a mid-high frequency speaker and are configured with the same frequency range and the same radiation characteristics. The central audio signals that drive the central speaker array are correlated with respect to the audio input signal.

The central speakers 1 and 2 are positioned longitudinally one behind the other so that their centers are located on an axis of symmetry in the longitudinal direction between the two head positions 21 and 22.

These head positions 21 and 22 represent ideal head regions of persons positioned on the left and right seats in the vehicle, respectively. The people look straight ahead in the direction of travel. Their head regions are arranged offset to the side of the central speakers 1 and 2.

A pair of seat speakers surrounding the head region is arranged in each seat. The seat speakers can be integrated into headrests. The first seat has a first pair of seat speakers with seat speakers 3 and 4. The second seat has a second pair of seat speakers with seat speakers 5 and 6.

The pairs of seat speakers are arranged centrally to the respective head region and spatially surround it. Their audio signals are decorrelated relative to the input signal and can, for example, exhibit reverberation effects.

Between the two central speakers 1 and 2, two zero points 11 and 12 are shown, which are located along symmetrical axes (relative to the speaker axis), each of which is rotated relative to the longitudinal axis through the speaker centers. These zero points result from the dipole radiation characteristics of the central speakers, wherein the audio signal of the second central speaker 2 is inverted and delayed in time compared to the first central speaker 1.

The zero points 11 and 12 are directed at the lateral head regions 21 and 22, respectively, more precisely at the side regions pointing towards the center, where the persons' ears are located. Thus, the zero points partially overlap the ear regions in the heads and produce a reduced sound pressure there.

This means that each listener's perception of the sound source center of the virtual soundstage is centered in front of his or her head region. The virtual soundstages are represented by thick arrows positioned in front of the head regions.

All speakers are connected to a signal processing unit (not shown), which receives an input audio signal and generates the central and seat speaker signals accordingly and controls the speakers individually.

This audio system with a central speaker array and side seat speakers can create personalized, virtual sound spaces for each listener in the vehicle, creating an impressive, enveloping sound experience.

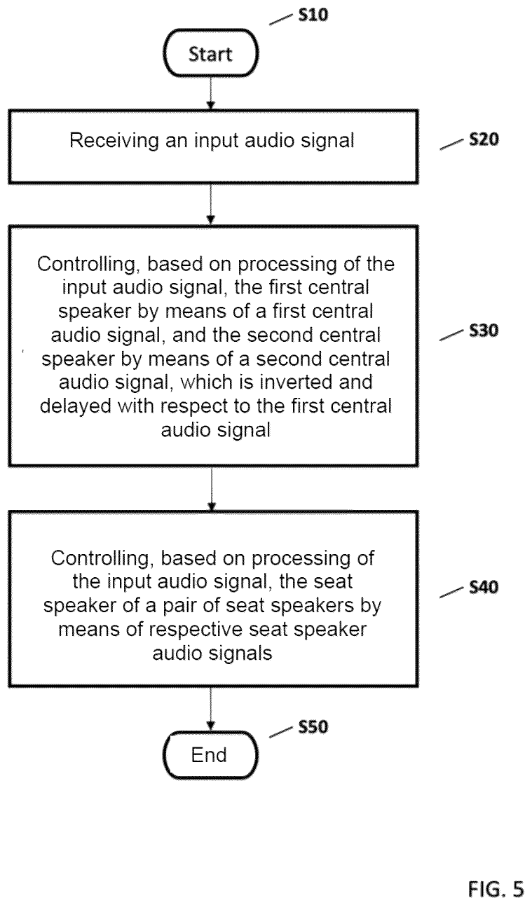

FIG. 5 shows a flow chart with steps for carrying out a method for generating virtual soundstages, according to various exemplary embodiments.

The method can be implemented, for example, by a signal processing unit of a (vehicle-) audio system and starts in step S10. In step S20, an input audio signal is received. In step S30, based on processing of the input audio signal, the first central speaker is controlled by means of a first central audio signal, and the second central speaker is controlled by means of a second central audio signal inverted and delayed with respect to the first central audio signal. In step S40, based on processing of the input audio signal, the seat speakers of one pair of seat speakers, or both pairs of seat speakers, are controlled by means of respective seat speaker audio signals. The seat speaker audio signals contain audio signals that are decorrelated with respect to the input audio signal and/or the central audio signals, creating the effect of an enveloping virtual soundstage that is perceived for each vehicle seat with an individually different center.

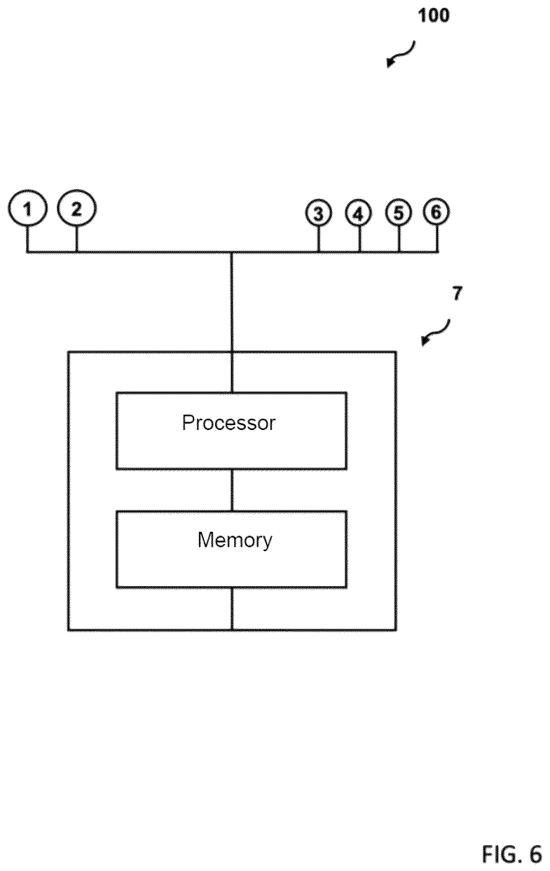

FIG. 6 shows a schematic drawing of an audio system 100 configured to generate virtual soundstages, according to various exemplary embodiments.

FIG. 6 schematically shows an audio system 100 for generating a virtual soundstage in a vehicle interior, comprising a signal processing unit 7 connected to central speakers 1, 2, and seat speakers 3, 4, 5, 6.

The signal processing unit 7 contains at least one processor and memory for processing audio signals, as well as an interface for receiving and providing audio signals, wherein the memory unit comprises instructions executable by the computing unit which, when executed by the computing unit, cause it to carry out the steps of any method or any combination of methods according to the present disclosure. The central speakers 1 and 2 form the central speaker array. The seat speakers 3, 4 and 5, 6 represent pairs of seat speakers, each surrounding the head regions of the persons on the seats.

The signal processing unit receives an input signal and controls the speakers based on this signal to create an individual virtual enveloping soundstage for each listener in the vehicle. It enables sound envelopment (surround effect) of the virtual seat-centered soundstage around the listener, extending around the listener.

### From the Above, the Following Conclusions can be Drawn:

In general, the radiation characteristic (directional characteristic) resulting from the time shift can be simplified as a rotated dipole characteristic. In detail, however, by shifting the zero point, the radiation characteristic may not have a complete dipole characteristic (rotated dipole), but a different directional characteristic (polar pattern) with a zero point located at a different spatial position. By controlling the spatial position of the zero point, the zero point is maintained, wherein it is located in a new spatial position, but the pattern around the zero point may change. This can be called a controlled dipole.

The volume level of the first and second central audio signals can be adjusted based on the time offset of the central audio signals to create a more realistic spatial listening effect.

In addition, in a minimum phase tuning, a frequency response of the first and/or the second speaker signal can be adjusted based on the time duration in order to further improve the spatial (enveloping) listening effect.

The audio signal can correspond to a left or right channel of a stereo audio signal. Another stereo channel can be reproduced simultaneously by the same audio system for the listener using the disclosed method.

The first central audio signal can be inverted to generate the second speaker signal, producing a radiation characteristic of the speakers that corresponds to a figure-eight dipole with a zero point (zero pole) at its center. The radiation characteristic of a figure-eight dipole is highly directional, meaning that the energy is radiated mainly in two main lobes that are perpendicular to the zero axis (or zero plane). The main lobes are located in the directions of the two halves of the figure-eight, and the dipole characteristic has a zero in the direction of the “loop” of the figure-eight.

A time shift (by a predetermined period of time) may be added to the first or second speaker signal. A spatial position of the zero point is determined by the time duration of the speaker signals relative to each other based on interference effects of the sound (pressure) waves.

The zero point is directed towards one of the listener's ears by the signal shift based on the duration. The virtual soundstage is created by all speakers emitting sound signals based on their respective audio signals, which can be perceived by the listener. For example, a virtual soundstage for a listener is shifted to the left side by directing the zero point to the listener's right ear, and vice versa.

It will further be apparent to those skilled in the art that the disclosed techniques can be applied in a variety of applications in which a compact central speaker arrangement in combination with seat-centered individual near-field speakers is intended to produce a spatial listening impression. It is also possible to adjust the duration and the seat speaker audio signal, further based on information from a head tracking system that tracks and determines a listener's listening pose.

Using the techniques described, a seat-centered soundstage can be created in front of, to the left and to the right of the listener and around him. The dipole configuration of the speaker arrangement can provide a spatial listening experience with reduced computational effort and by combining it with seat speakers. For example, a phantom image in the center in front of the listener (0°) and a soundstage that extends to the left and right in front of the listener and surrounds him (+−180°) can be created. The soundstage can provide a sound envelope for the listener, with the soundstage extending around the listener and the center of the soundstage being perceived centrally in front of the seating position.

The seat speakers of a pair of seat speakers can be arranged both or each in the near field and/or in the diffuse field with respect to the head position. The distance of one or both speakers to a listener, or more generally to a position of a typical listening pose of a listener, may be less than 1 m, preferably less than 0.5 m, or more preferably less than 0.3 m. It is understandable for the person skilled in the art that other distances between speaker and listener are also possible.

It is conceivable that the time duration during playback of the audio signal is varied (in steps or continuously), and the first and second seat speakers are controlled using seat speaker signals generated using the varying time duration. For example, head tracking information can be taken into account.

In summary, the disclosed techniques are based on the following findings. The central compact speaker array, consisting of at least two central speakers, creates a dipole radiation characteristic with displaceable zero points by inverting and delaying the audio signals. These zero points can be aimed specifically at the side head regions of the listener, where the ears are located. This results in reduced sound pressure in this region. For each listener, the perception of the sound source center of the virtual soundstage is thus centered in front of his head. The impression is created of a personalized, seating position-centered soundstage. The pairs of seat speakers, each arranged around the head regions, complement this effect by spatial sound enveloping. Their decorrelated audio signals with reverb effects create immersion. The combination of these two components-centered sound image through zero-point superposition and spatial sound envelopment through near-field speakers-leads to an improved sound experience with a centered virtual stage and immersive sound environment.

What is claimed is:

1. An audio system for generating a virtual soundstage in a vehicle interior, the audio system comprising:
a speaker array comprising at least one first central speaker and at least one second central speaker arranged laterally in the vehicle interior between a first vehicle seat and a second vehicle seat;
a pair of seat speakers in each of the first vehicle seat and the second vehicle seat, wherein the pair of seat speakers is arranged so that a head region of a respective vehicle seat is arranged between the pair of seat speakers; and
a signal processing unit connected to speakers comprising the speaker array and the pair of seat speakers, and providing audio signals to speakers to generate sound signals, wherein the signal processing unit is configured to perform the steps of:
receiving an input audio signal;
controlling, based on processing the input audio signal, the at least one first central speaker based on a first central audio signal; and
controlling, based on processing the input audio signal, the at least one second central speaker based on a second central audio signal that is inverted and delayed with respect to the first central audio signal, wherein a first zero point in a radiation characteristic of sound signals of the speaker array encounters the head region of the respective vehicle seat laterally shifted relative to a center of the head region.

2. The audio system of claim 1, wherein the first zero point encounters the head region near a central side region of the head region, wherein the central side region faces another vehicle seat of the first vehicle seat and the second vehicle seat.

3. The audio system of claim 1, wherein the pair of seat speakers are headrest speakers in a headrest of the first vehicle seat.

4. The audio system of claim 1, wherein the at least one first central speaker and the at least one second central speaker are arranged in a compact spatial configuration, wherein a distance between the at least one first central speaker and the at least one second central speaker is less than 50% of a speaker diameter of one of the at least one first central speaker and the at least one second central speaker, or wherein the at least one first central speaker is adjacent to the at least one second central speaker.

5. The audio system of claim 1, wherein the at least one first central speaker is a first central speaker set that includes a first midrange component and a first tweeter component, and the at least one second central speaker is a second central speaker set that includes a second midrange component and a second tweeter component, wherein the first central speaker set and the second central speaker set are arranged in a dashboard of a vehicle or in a roof of the vehicle, and wherein the first central speaker set includes at least one of: a first frequency range that is the same as a second frequency range of the second central speaker set, or a first radiation characteristic that is the same as a second radiation characteristic of the second central speaker set.

6. The audio system of claim 1, wherein the first central audio signal comprises an audio signal correlated with the input audio signal.

7. The audio system of claim 1, wherein the signal processing unit is configured to perform the step of:
controlling, based on processing the input audio signal, the pair of seat speakers based on respective seat speaker audio signals, wherein a first seat speaker of the pair of seat speakers is controlled without a time delay relative to a second seat speaker of the pair of seat speakers.

8. The audio system of claim 7, wherein the respective seat speaker audio signals comprise audio signals that are decorrelated with respect to at least one of the input audio signal, the first central audio signal, or the second central audio signal.

9. The audio system of claim 7, wherein the respective seat speaker audio signals comprise reverberated audio signals with respect to at least one of the input audio signal, the first central audio signal, or the second central audio signal.

10. The audio system according to claim 1, wherein a first head region of the first vehicle seat is disposed in a left hemisphere of the speaker array, and a second head region of the second vehicle seat is disposed in a right hemisphere of the speaker array, and a center of the speaker array is disposed on a longitudinal axis between the first head region and the second head region.

11. The audio system according to claim 1, wherein the first zero point of the speaker array is located at least partially in a first center-facing side region of a first head region of the first vehicle seat, and a second zero point of the speaker array, which is symmetrical to the first zero point with respect to a speaker axis passing through the centers of the first and second central speakers, is located at least partially in a second center-facing side region of a second head region of the second vehicle seat.

12. The audio system according to claim 11, wherein the speaker axis extends between the first vehicle seat and the second vehicle seat.

13. The audio system according to claim 1, wherein the at least one first central speaker and the at least one second central speaker are arranged on a longitudinal axis of symmetry with respect to a first head region of the first vehicle seat and second head region of the second vehicle seat.

14. A method for generating a virtual soundstage in a vehicle interior based on an audio system comprising:
a speaker array comprising at least one first central speaker and at least one second central speaker arranged laterally in the vehicle interior between a first vehicle seat and a second vehicle seat;
a pair of seat speakers in a vehicle seat of the first vehicle seat and the second vehicle seat, wherein the pair of seat speakers is arranged so that a head region of the vehicle seat is arranged between the pair of seat speakers; and
a signal processing unit connected to speakers comprising the speaker array and the pair of seat speakers, and providing audio signals to speakers to generate sound signals, wherein the method is carried out by the signal processing unit, the method comprising:
receiving an input audio signal;
controlling, based on processing the input audio signal, the at least one first central speaker based on a first central audio signal; and
controlling the at least one second central speaker based on a second central audio signal that is inverted and delayed with respect to the first central audio signal, wherein a first zero point in a radiation characteristic of sound signals of the speaker array encounters the head region of the vehicle seat laterally shifted relative to a center of the head region.

15. The method of claim 14, wherein the first central audio signal comprises an audio signal correlated with the input audio signal.

16. The method of claim 14, further comprising:
controlling, based on processing the input audio signal, the pair of seat speakers based on respective seat speaker audio signals, wherein a first seat speaker of the pair of seat speakers is controlled without a time delay relative to a second seat speaker of the pair of seat speakers.

17. The method of claim 14, wherein a first head region of the first vehicle seat is disposed in a left hemisphere of the speaker array, and a second head region of the second vehicle seat is disposed in a right hemisphere of the speaker array, and a center of the speaker array is disposed on a longitudinal axis between the first head region and the second head region.

18. The method of claim 14, wherein the first zero point encounters the head region near a central side region of the head region, wherein the central side region faces another vehicle seat of the first vehicle seat and the second vehicle seat.

19. The method of claim 14, wherein the pair of seat speakers are headrest speakers in a headrest of the first vehicle seat.

20. A vehicle comprising an audio system, the audio system comprising:
a speaker array comprising at least one first central speaker and at least one second central speaker arranged laterally in the vehicle interior between a first vehicle seat and a second vehicle seat;
a pair of seat speakers in a vehicle seat of the first vehicle seat and the second vehicle seat, wherein the pair of seat speakers is arranged so that a head region of a person sitting on the vehicle seat is arranged between the pair of seat speakers; and
a signal processing unit connected to speakers comprising the speaker array and the pair of seat speakers, and providing audio signals to speakers to generate sound signals, wherein the signal processing unit is configured to perform the steps of:
receiving an input audio signal;
controlling, based on processing the input audio signal, the at least one first central speaker based on a first central audio signal; and
controlling, based on processing the input audio signal, the at least one second central speaker based on a second central audio signal that is inverted and delayed with respect to the first central audio signal, wherein a first zero point in a radiation characteristic of sound signals of the speaker array encounters the head region of the vehicle seat laterally shifted relative to a center of the head region.
